(19) United States
(12) Patent Application Publication
(10) Pub. No.: US 2006/0115104 A1
(43) Pub. Date: Jun. 1, 2006

(54) Method of manufacturing an active hearing device and fitting system

(76) Inventor: Michael Boretzki, Ruti (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/998,752

(22) Filed: Nov. 30, 2004

(51) Int. Cl. H04R 25/00

(52) U.S. Cl. 381/322

(57) ABSTRACT

A method for manufacturing an active hearing device which is fitted towards the needs of an individual includes manufacturing an active hearing device with at least one adjustable transfer characteristic between an acoustic input signal and a mechanical output signal; categorizing an acoustic signal to be applied as a fitting signal as being one of several pre-established types of signals; automatically determining from the one type a selection of preferred adjustments to be acted upon at the device, and acting on at least one adjustment selected from the selection. A fitting system for a hearing device has a unit with an input operationally connected to an acoustic signal source and generating at an output a signal representative of a selection of preferred adjustments to be acted upon at a hearing device for fitting same with respect to a specific signal.

The present invention departs from the following problems:

Whenever an active hearing device is manufactured and sold to an end user—the individual who finally will wear such hearing device—fitting of the hearing device to such individual's proper needs in its real, daily acoustic surrounding is difficult to achieve. Thus, there is a problem to perform hearing device fitting getting real-life acoustic signals well considered, be it within the fitter's office or by in situ fitting the device under real life conditions.

A further problem which is more and more encountered in complex multi-transfer characteristics, i.e. multi-program digital hearing devices is that the fitter such as e.g. an audiologist has a difficult task to provide proper fitting of the hearing device to different acoustic test signals without influencing by one fitting adjustment operation at least some of the adjustment operations which have already been performed for other test signals. Often looping or fitting operations for different test signals is necessary.

Still a further problem which is encountered in the art of hearing device fitting is that often standard test signals are to be applied if the respective fitter wants to accurately rely on pre-established fitting rules and fitting advice provided by fitting system manuals and/or automatic fitting menu control.

It is an object of the present invention to provide a solution which is suited to resolve the above mentioned problems.

This is achieved according to the present invention by a method of manufacturing an active hearing device which is fitted towards the needs of an individual and which comprises
manufacturing an active hearing device having at least one adjustable transfer characteristic between an acoustic input signal and a mechanical output signal;
categorizing an acoustic signal to be applied as fitting signal as being one of several pre-established types of fitting signals;
automatically determining from said type a selection of preferred adjustments to be acted upon at said device;
acting on at least one adjustment selected from said selection.

### DEFINITIONS

We understand under an “active hearing device” a hearing device which is, on the output side, operatively connectable to the ear of an individual and provides there for hearing perception of signals as input. The output signal is primarily a mechanical signal, namely an acoustic signal as output by a loudspeaker arrangement or a movement signal operating upon a mechanical transducer as implanted or applied to an individual's ear. Nevertheless, if we address such “output signal” this may also refer to an electric signal upstream electric/mechanical conversion.

At the input side the “active hearing device” receives either directly an acoustic signal which is then converted to an electric signal as by an acoustic/electric converter arrangement or an electric representation of such acoustic signal, whereby the latter is a result of remote and/or pre-performed acoustic to electric conversion. The device is called “active”, because there is provided an electronic unit, thereby especially at least one digital signal processing unit, which operates upon the input signal with a prevailing transfer characteristic to provide the output signal.

Therefore, if we speak generically and in the following description of an input signal to the active device, it may be acoustic or electric. In analogy, if we speak of an output signal of the hearing device, it may be mechanical or electric.

If we speak of a “prevailing transfer characteristic” of the active hearing device, it is the momentarily active characteristic with which the input signal is transferred to the output signal primarily by the electronic unit within the hearing device.

One hearing device considered may have two or more transfer characteristics which are selectively activatable in the sense of different programs, so e.g. to perform signal transfer for different acoustic situations. The one or more than one transfer characteristics are parameterized by adjustable parameters. Thus, if we speak of a “selection of adjustments” such selection may comprise one or more than one transfer characteristics and adjustable parameters of one or more than one transfer characteristics.

If we speak of a “fitting operation” or fitting procedure, we understand any procedure during which parameters of one or more than one transfer characteristics are adjusted. A fitting operation may be a “default” fitting operation of the hearing device, during which a freshly manufactured device is first adjusted, so that the one or more than one transfer characteristics are parameterized on default behavior.

A fitting operation may also be a “preliminary” fitting operation, during which, departing from the just addressed default fitting adjustment, the hearing device is adjusted with respect to its one or more than one transfer characteristics to specific needs which are reported by a customer individual of a specific hearing device. This “preliminary” fitting operation deals with data specific to that individual which is present in a prerecorded form, such as e.g. diagnostic data about the specific hearing ability of that individual.

A fitting operation may be “fine”-fitting of the hearing device to the specific customer individual, which is done in situ, i.e. during said individual wearing the hearing device. It is largely controlled by intense communication between the individual and a specialized operator.

Finally, fitting operation may be “user”-fitting, where the customer individual wears the hearing device and adjusts one or more than one parameters of one or more than one transfer characteristics of the hearing device in normal life acoustic environment.

We understand under a “type” of an acoustic signal or of its electric representation one of several pre-established categories of acoustic signals. Acoustic signal types may be e.g.:

from daily life acoustic surrounding:
speech in specific languages, further dependent on gender of speaker, etc.;
different noises, such as e.g. airplane noise, car noise, wind noise, etc.
different kinds of music and dependent on prevailing acoustic surrounding such as in the car, in a small room, in a concert hall, etc.

artificial:
artificial acoustic signals pre-mixed with specific spectral power distribution such as e.g. standard test signals.

Further, different “types” of acoustical signals or of their electric representations may be defined by different basic acoustical parameters as e.g. different level, different spectra, different time courses of spectral distribution or levels, etc.

Further, such “types” may be defined by different acoustic indicators of content, namely e.g. of music, speech, traffic noise, etc.

Still further “types” may be defined on the basis of different indicators of specific acoustic sources, as e.g. by specific talkers, specific music instruments, orchestras, spatial location, etc.

Still further, the addressed “types” may be defined on the basis of different indicators of probable hearing target being associated with an acoustic signal, as e.g. intelligibility, clarity, audibility, pleasantness, noisiness, etc.

Due to the fact that, according to the principal of the present invention, there is automatically proposed a selection of adjustments for the hearing device which should be preferably acted upon when fitting for a specific acoustic signal, even for highly complex multi-transfer characteristic hearing devices, a significant help is given to the fitter to purposefully perform the adjustment of the hearing device.

Further, categorizing of an acoustic signal to be applied as a fitting signal and performing the determination of the proposed selection of preferred adjustments allows to use momentarily prevailing daily signals for fitting. Such signals are categorized automatically, i.e. “online” or, if prerecorded e.g. selected by an audiologist, are pre-categorized. Further, artificial standard test signals may be used for fitting, which are accordingly categorized in advance. Thus, all kinds of momentarily prevailing or of prerecorded acoustic signals may be used as fitting test signals and the automatic determination of a proposed selection for preferred adjustments to be acted upon allows acting upon those adjustments which are specific to the test signals. Such proposed selection will e.g. influence significantly less the transfer of other signals, which has possibly already been optimized, than that of the just selected signal.

From EP 1 453 356 it is known to automatically classify a prevailing acoustic situation and to provide for a plurality of adjustment configurations in dependency of the classification result. Selection of a specific adjustment configuration out of a group of adjustment configurations is performed interactively. Fitting is realized just by selecting a preferred adjustment configuration. Thus, in contrast to the present invention, not a selection of adjustments which may be obeyed or not is proposed, but there an adjustment configuration defining for final quantitative adjustment values is provided. Thereby, e.g. an individual adjustment taking into account the needs and possibly even varying needs of such individual may not be performed.

From EP 1 453 357 it is known, in context with hearing device fitting, that a user of the hearing device performs a manual adjustment in an acoustic situation which is characteristic for the user. After proper adjustment the prevailing acoustic situation is acoustically measured and the measurement result as well as the manually selected adjustment is exploited to calculate a new set of characteristics. Within this set of characteristics a multitude of acoustic situations are assigned to respective adjustments.

Finally, it is known from WO 99/53742 from the same applicant as the present invention to control an audio storage player unit by a calculator unit of a fitting system, the audio output of such player unit being operationally connected to a loudspeaker unit, Thereby, it becomes possible to automatically select an audio test signal to be presented next for fitting dependent on past fitting operations.

Turning back to specific embodiments of the present invention, in one embodiment categorizing an acoustic signal to be applied as a fitting signal is performed by analyzing said acoustic signal as prevailing. Thereby, momentarily prevailing acoustic signals may be analyzed and categorized, leading to the ability that an individual wearing the hearing device in situ gets information about preferred adjustments to be acted upon for the prevailing acoustic situation. This is due to the fact that from such categorizing which is based on signal analysis, automatically a selection of preferred adjustments is determined as a proposal, which significantly facilitates the customarily not specialized individual to perform a fitting adjustment in the prevailing acoustic surrounding. Such most flexible in situ fitting option allows the end user individual to user fit his hearing device whenever felt necessary.

Thereby, in one embodiment the result of signal analyzing just addressed is compared with predetermined values which concomitantly define for pre-established types of acoustic signals and thereby the prevailing acoustic signal is assigned to one of these types.

In one embodiment the addressed analyzing comprises analyzing of prevailing acoustic signals by at least one of the following methods:
analyzing basic acoustical parameters as e.g. level, spectrum, time course of spectral levels, etc.;
analyzing acoustic indicators of content type of acoustic signals as e.g. music, speech, traffic noise, etc.;
analyzing acoustic indicators of specific acoustic sources as e.g. of specific talkers, orchestras, spatial location, etc.;
analyzing acoustic indicators of a probable hearing target being associated with an acoustic signal as e.g. by intelligibility, clarity, audibility, pleasantness, noisiness, etc.

In one embodiment the selection of preferred adjustments as determined comprises one or more than one adjustment parameters of one or more than one transfer characteristics of the device as well as the indication of the respective transfer characteristic or transfer characteristics.

In a further embodiment the selection of the preferred adjustment additionally depends on one or more than one of the following factors:
current settings of the hearing device;
individual hearing loss of the user of the hearing device;
individual listening needs of the user of the hearing device;
deviation of the current settings of the hearing device from pre-established output targets for the acoustic signal;
previously selected adjustments for the same or for other acoustic signal types;
result of previous adjustments for the same or for other acoustic signal types.

In one further embodiment of the method according to the present invention the acoustic signal to be applied is prerecorded. Thereby, the option is opened that a specialized person such as e.g. an audiologist may prerecord natural acoustic signals he considers well suited for hearing device fitting and the type of such prerecorded signal is either predetermined before a fitting operation is performed and then such predetermined type information is just entered to the fitting system for automatically displaying a proposed selection of adjustments to be acted upon. Alternatively, such prerecorded signal may be subjected to automatic categorizing as by the addressed analyzing.

As was mentioned above the present invention makes use of categorizing an acoustic signal to be applied as a fitting signal as being one of several pre-established types of signals. Thereby, and especially with an eye on default fitting, it is not necessary that such an acoustic signal be in fact applied to the hearing device during fitting. Once for an acoustic signal which is suited as a fitting signal, the type has been found by categorizing, it may be sufficient just to automatically determine the selection proposal of preferred adjustments for that specific suited signal and then to act upon such proposed adjustment without really presenting the respective acoustic signal to the hearing device.

Thus, e.g. a default fitter may just subsequently enter different type information to the automatic determination of a respectively proposed selection and may, following up such proposal, perform adjustments upon the hearing device without the respective acoustic signal being presented. Such a fitting without presenting acoustic signals during fitting may also be performed possibly for preliminary fitting, i.e. during all fitting operations, where a customer individual needs not yet be considered with respect to his individual in situ hearing perception.

Whenever the acoustic signal to be applied or which is suited to be applied is in fact applied to the hearing device and/or to categorizing, in one embodiment this is performed via an acoustic to electrical conversion.

In one further embodiment the acoustic signal to be applied as a fitting signal is presented to an acoustic to electric converter arrangement of the hearing device. This is especially done whenever a fitting operation is performed, whereat the perception of a customer individual is considered in situ.

Following up a further embodiment of the present invention a signal which depends on the output signal of the hearing device is displayed, e.g. on a display screen, and the automatically determined proposed selection of preferred adjustments as well.

In a further embodiment the signal which is displayed and which depends on the output signal of the hearing device may be indicative of at least one or a combination of the following indicators:
basic acoustic parameters as e.g. level, spectrum, time course of spectral level of the acoustic signals or their electric representation;
acoustic indicators of content type of the acoustic signals or their electric representation as e.g. of music, speech, traffic noise;
acoustic indicators of specific acoustic sources generating the acoustic signals or their electrical representations as e.g. specific talkers, specific grouping of orchestras, specific instruments, spatial location, etc.;
indicators of probable hearing targets being associated with the acoustic signals or their electric representations as e.g. intelligibility, clarity, audibility, pleasantness, noisiness, etc.

An individual which perceives the displayed information acts upon at least one of the adjustments as proposed by the displayed selection. This embodiment is e.g. practiced by a specialized person such as by an audiologist. Because the displayed selection does not contain information about quantitative adjustment or variation of the respective parameters, generically a specialized person will be necessary to properly select how much and which of the selected adjustment options shall be varied. To do so the addressed individual should know the target of such an adjustment.

Therefore, in a further embodiment the addressed individual is provided with target information for said output signal and the individual performs acting upon an adjustment
a) in dependency of such target information,
b) as a function of the automatically determined selection,
c) as a function of the prevailing output signal-dependent signal as displayed.

In a still further embodiment the desired output signal is electronically provided for the acoustic signal which is applied. There is further formed, electronically, a deviation signal between the output signal of the hearing device and the desired output signal. The deviation signal is fed to an individual. Further, there is fed to the addressed individual information about the proposed selection of preferred adjustments and it is this individual who performs acting upon at least one adjustment as a function of the addressed information about the preferred selection and of the addressed deviation.

Thereby, in fact, the addressed individual, e.g. an audiologist, is supplied with automatically calculated deviation information, i.e. the deviation between the output signal as it should be (target) and the output signal as it really is. Due to the proposed selection such individual may now easily adjust the hearing device by acting upon one or more than one of the proposed adjustments, which is especially important if at the hearing device a huge number of different adjustments is available.

In a further embodiment of the present invention the hearing device is applied to an individual. The information about the proposed selection of preferred adjustment is displayed to such individual, and it is this individual acting upon the at least one adjustment of the displayed selection of adjustments.

Thereby, in fact the individual may especially be the customer individual and does thereby apply “user” fitting.

Departing from the just addressed embodiment the information about the proposed selection of preferred adjustments is transmitted to the individual in one further embodiment by an automatically generated acoustic speech signal.

In a still further embodiment at least the automatic determining is performed within the hearing device. The individual is provided with voice information about the proposed selection of preferred adjustments via the output electric to mechanical converter of the worn hearing device. Thus, in this embodiment the user customer may user fit easily the worn hearing device in normal acoustic surrounding, especially if categorizing the prevailing acoustic signals is also performed within the hearing device as by the addressed analyzing.

Still in a further embodiment of the invention the acoustic signal to be applied is in fact applied to a first individual via the hearing device which is worn by this first individual. The information of the proposed selection of preferred adjustments is provided or displayed to a second individual Further, information about hearing perception of the first individual is transmitted to the second individual, who performs acting upon at least one adjustment out of said proposed selection.

The skilled artisan who has been taught by the presently described invention may realize such invention in terms of fitting system hardware in a huge number of different manners. Nevertheless, generic to all such systems is that such system comprises a unit with an input operationally connected to an acoustic signal source which unit generates at an output a signal which is representative of a selection of preferred adjustments to be acted upon at a hearing device for fitting such hearing device with respect to a specific acoustical signal.

Thereby, “operationally connecting” the addressed signal source to the addressed unit may be done, as became clear from the explanations already given above, via a categorizing unit which determines the type of acoustic signal prevailing or may, most indirectly, be done just by entering information about a pre-established type of acoustic signal so as to generate by the cited unit the addressed selection of preferred adjustments which should be acted upon. In one embodiment of such fitting system the addressed unit is integrated into a hearing device, thereby defining for a hearing device with such unit.

The present invention is especially preferred for appliances where an individual is involved in fitting adjustment.

The present invention shall now further be exemplified with a more detailed description of examples of embodiments, which description shall be done with the help of figures. These figures show:

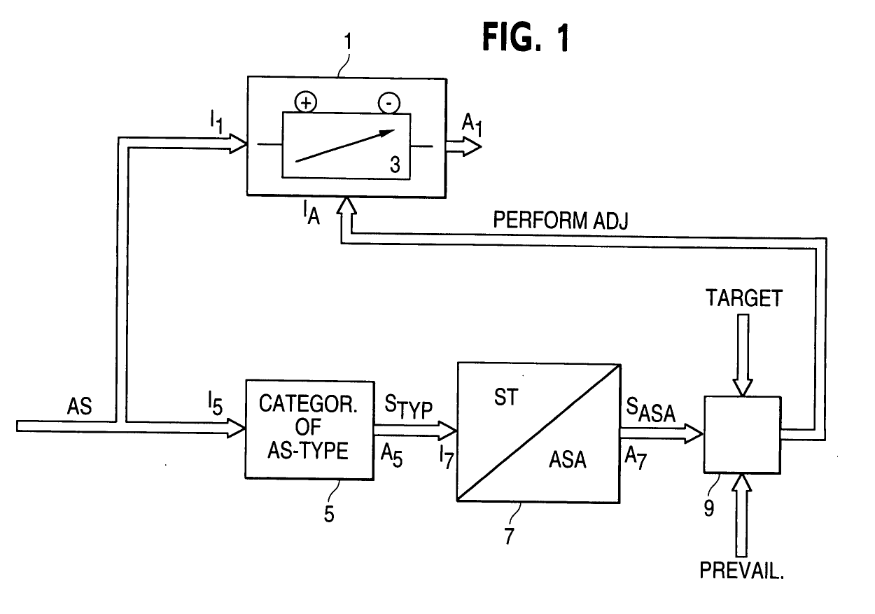

FIG. 1 By means of a signal flow/functional block diagram, the generic principal of the present invention;

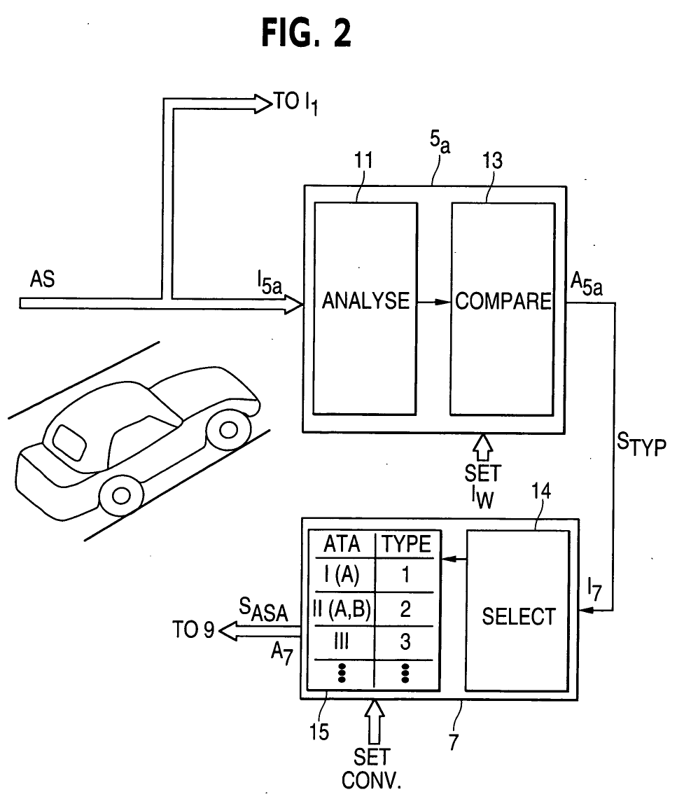

FIG. 2 by means of a signal flow/functional block diagram, one embodiment of realizing a signal type/adjustment selection advice conversion unit (ST/ASA) applied according to the present invention;

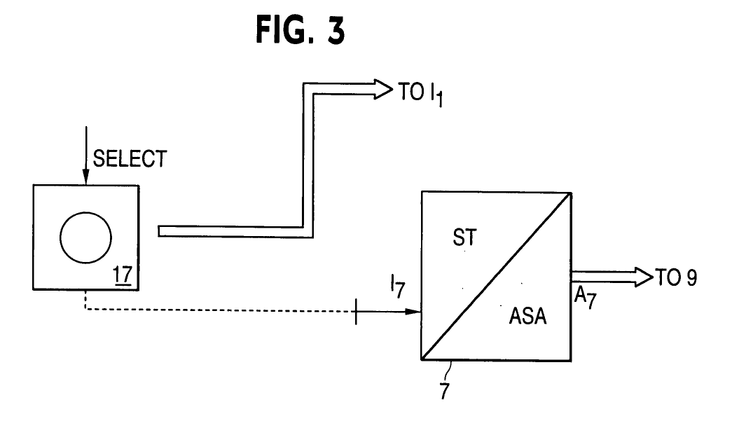

FIG. 3 by means of a simplified signal flow/functional block diagram, an embodiment according to the present invention, whereat categorizing of acoustic signal type is performed previous to a fitting operation;

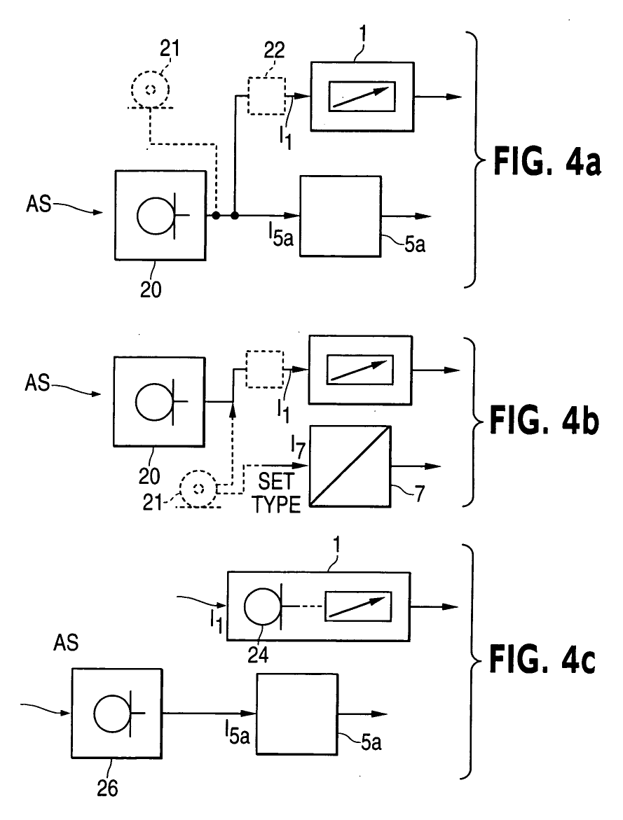

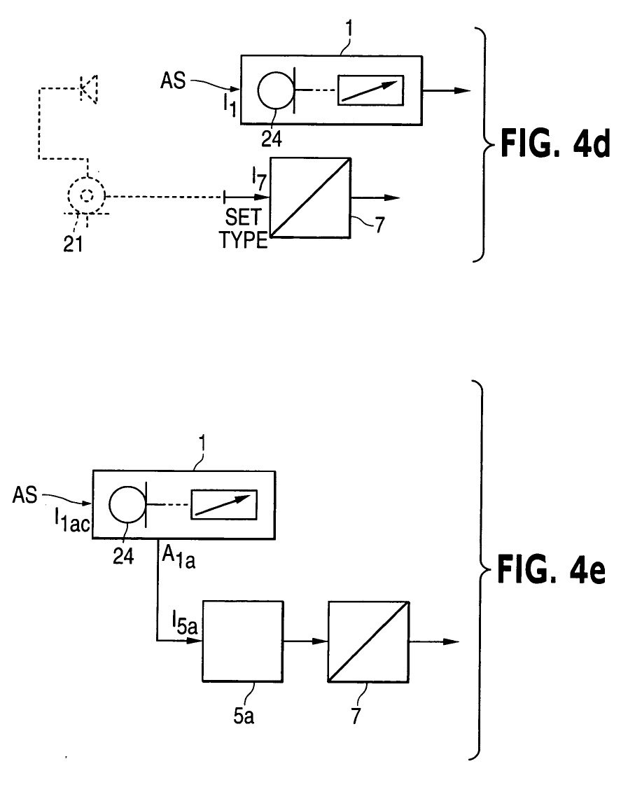

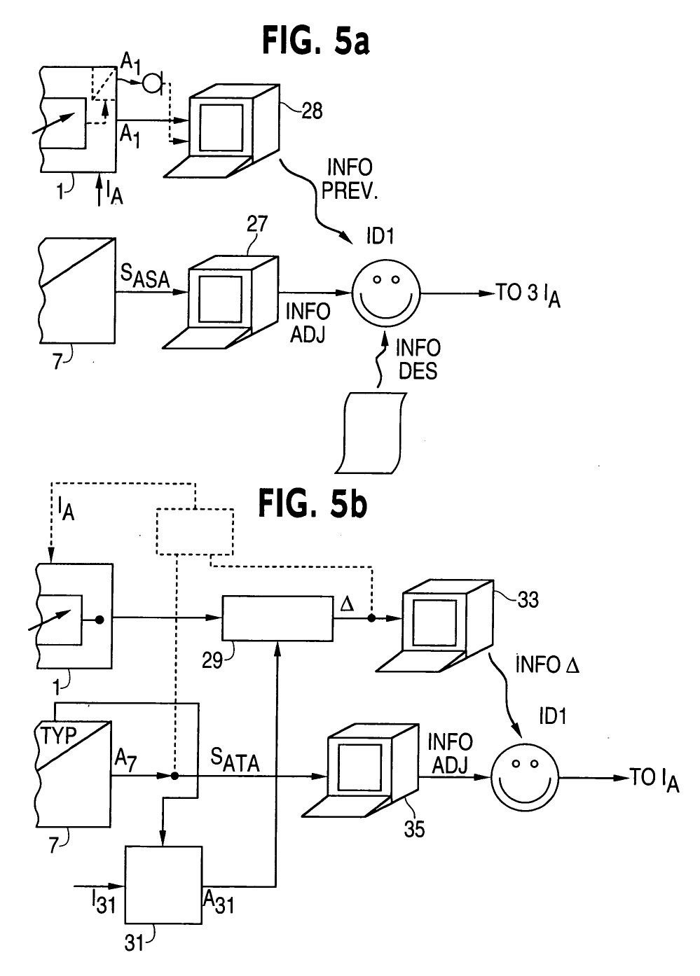

FIGS. 4a-4e by means of simplified signal flow/functional block diagrams, embodiments of the present invention with an eye on different techniques of exploiting acoustic signals which are suited as fitting test signals;

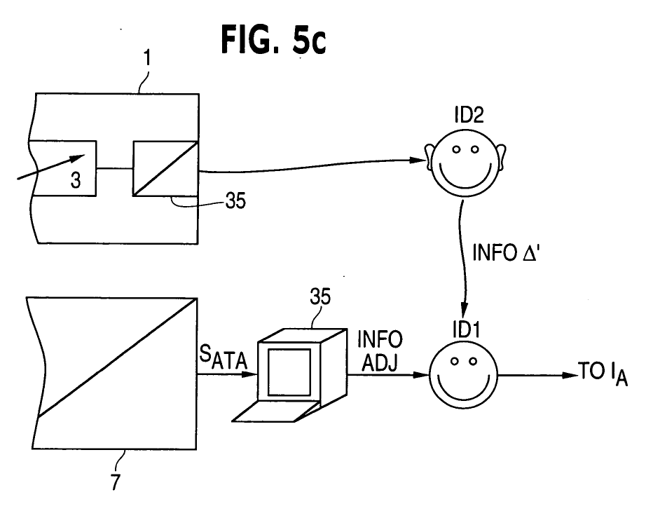

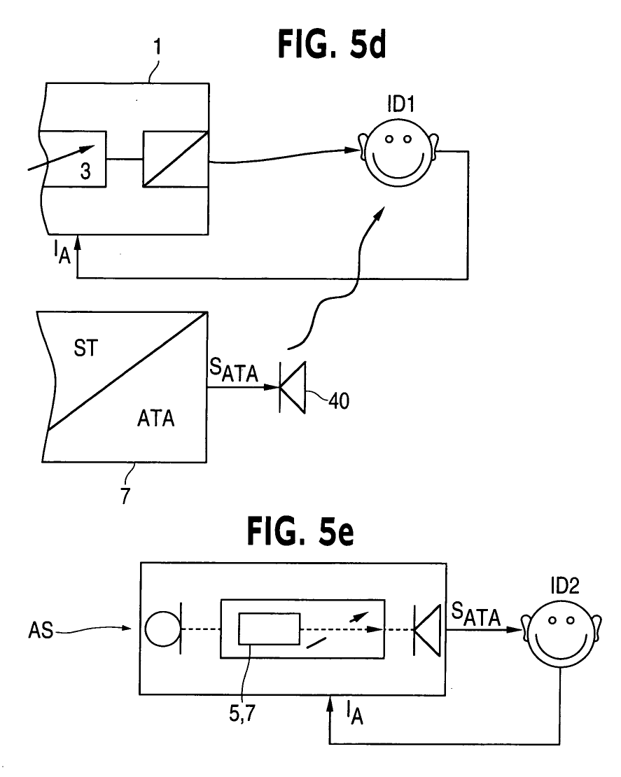

FIGS. 5a-5e by simplified functional block/signal flow diagrams, different techniques according to the present invention to finally act upon the adjustment of a hearing device in dependency of the information about selection of proposed adjustments to be acted upon.

### DETAILED DESCRIPTION OF THE INVENTION

In FIG. 1 there is shown by means of a signal flow/functional block diagram most generically a fitting system according to the present invention and operating according to the present invention so as to manufacture active hearing devices which are fitted towards the needs of an individual.

With the definitions as addressed above in mind it may be seen that according to FIG. 1 an acoustic signal AS is operatively applied as an input signal I₁ to an active hearing device 1. For certain fitting operations it may not be physically applied to the device 1 but just be a signal considered to be suited for fitting the hearing device 1. This shall also be understood as within the scope of “operatively applied”. An electronic unit 3 within the hearing device 1, customarily comprising one or more than one digital signal processing units (DSP) for digitally treating the input signal applied at I₁, provides via a prevailing transfer characteristic for the output signal A₁ of the hearing device. As generically shown in the representation of FIG. 1 the electronic unit 3 providing for the one or, selectably, more than one transfer characteristics, is adjustable, i.e. one or more than one parameters of one or more than one transfer characteristics may be adjusted which is, generically, performed by an actuation at an input at I_{A} to the hearing device 1 and the electronic unit 3. Under a most generic aspect the adjustment input at I_{A} may be a manual input or may be an electric input which actuates such adjustment.

The acoustic signal AS is operationally connected to an input I₅ for “type” categorizing as by a unit 5.

“Type” determination provides for an output signal S_{TYP} which is indicative of a specific type of a specific acoustic signal AS out of several such “types”.

According to a pre-established multitude of “types” of acoustic signals categorizing criteria are preset. Categorizing may be performed at a categorizing unit 5, which, as will be explained later, may be omitted if the “type” of acoustic signal AS is known, such as e.g. having been predetermined.

Thus, and according to FIG. 1 the categorizing unit 5 represents generically a function resulting in the knowledge of the “type” of acoustic signal AS suited for fitting device 1.

The categorizing unit 5 thus provides at a generalized output A₅ a signal S_{TYP} indicative for the “type” of acoustic signal to be used as a fitting test signal. This “type” information in S_{TYP} is applied to an input I₇ of a signal type to adjustment selection advice conversion unit 7 called ST/ASA conversion unit. This ST/ASA conversion unit 7 may e.g. incorporate a lookup table, each “type” of acoustic signal defining for a proposed selection of adjustments to be possibly acted upon at the electronic unit 3.

At an output A7 of ST/ASA conversion unit 7, an indication signal S_{ASA} is generated. As an example: If the acoustic signal AS represents classical music in a huge concert hall and is accordingly categorized, the ST/ASA conversion unit 7 may e.g. output an indication that for influencing the transfer characteristic of the device 1 for such an acoustic signal, predominantly transfer characteristic No. X—program No. X—should be adjustably acted upon and within such transfer characteristic No. X, the parameters A, B, C out of parameters A, B, C, D, E should be varied.

For a specialized person performing default, preliminary or individual fitting operation on the device 1 it is a substantial help to get from such information S_{ASA} the knowledge where primarily to perform an adjustment operation at the unit 3.

As further schematically shown in FIG. 1 there is, most generically, provided an adjustment-performing member 9, which on one hand receives the indication of S_{ASA} from conversion unit 7 and, on the other hand, performs according to such advice contained in S_{ASA} received from conversion unit 7, the respective adjustment or adjustments at the electronic unit 3 of device 1, thereby acting on I_{A}.

If the adjustment member 9, which, under the most generic aspect of the present invention, may be an individual—preferred—or an electronic unit, shall perform an adjustment of a transfer characteristic at unit 3 towards a desired target characteristics in the sense that a prevailing input signal at I₁ shall result in a desired output signal at A₁, then—as shown in FIG. 1—the adjusting member 9 additionally receives target output signal information on one hand and on the other hand prevailing output signal information, i.e. information about the prevailing output at A₁.

Online categorizing acoustic signals as for exploiting daily life acoustic surrounding for fitting, necessitates categorizing being online performed. This is shown schematically and simplified in FIG. 2. Thereby, categorizing a prevailing signal as a specific “type” is done by online signal analysis and then categorizing the analyzing result.

According to FIG. 2 acoustic signals AS are input to a categorizing unit 5a. There, in a first stage 11 the input signal is analyzed. Thereby, the acoustic signals may be analyzed on at least one of the following criteria:
basic acoustic parameters, i.e. e.g. level, spectral distribution, time course of spectral distribution, etc.;
acoustic indicators of a content type of the acoustic signals as e.g. music, speech, traffic noise, etc.;
acoustic indicators of specific acoustic sources as e.g. specific talkers, spatial location, etc.;
acoustic indicators of probable hearing targets for an individual, which are associated with the acoustic signal as e.g. intelligibility indicators or indicators of clarity, audibility, pleasantness, noisiness of the acoustic signals.

The analysis result, e.g. spectral power distribution of the input signal, is compared in a subsequent comparison stage 13 with pre-established values, resulting in the prevailing signal being categorized as one specific “type”. As schematically shown in FIG. 2 categorizing criteria are pre-established, input and stored in determination unit 5ₐ as via a set input I_{W}. For a prevailing signal AS at I₅ₐ the determination unit 5ₐ outputs, at output A₅ₐ the signal S_{TYP} indicative for the “type” of prevailing signal at I₅ₐ. This signal is applied to input I₇ of ST/ASA conversion unit 7. By means of a select stage 14 the respective “type” field is addressed in conversion stage 15 which is assigned to a specific selection of preferred adjustments ASA. As an example, whenever a “type 1” signal is the result of categorizing in unit 5a there is generated an ASA signal at the output A₇ indicating that for fitting the electronic unit 3 of device 1 predominantly adjustments I, e.g. parameter A of transfer characteristics I should be acted upon. Accordingly and as shown fitting for a “type 2” input signal is advised to be performed by acting at characteristic II on parameters A and B.

As schematically shown in FIG. 2 the definition of respective conversion from a signal type to a preferred adjustment to be acted upon is set at a SET CONV input to unit 7. One “type” considered may thereby be linked to more than one different selections of preferred adjustments. This may be done additionally in dependency on at least one of the following factors:
the current settings of the hearing device;
data of an individual hearing loss of the user of the hearing device;
individual listening needs of the user wearing the hearing device;
deviations of the current settings of the hearing device from pre-established output targets for the acoustical signal or from default settings;
previously selected adjustments for the same or for other acoustic signal types;
results of previous adjustments for the same or for other acoustic signal types.

Thus, in unit 7 a two- or more-dimensional lookup table may in fact be implemented assigning to one specific “type” of signal input at 17 and dependent on additional parameters input to unit 7 (not shown) selectively different selections of respectively preferred adjustments to be acted upon at the device 1 of FIG. 1.

In fact by providing signal analyzing and categorizing at 11, 13, then conversion—14, 15—, all kinds of signals at I₅ₐ may be treated. Nevertheless, some acoustic signals used for fitting are much easier to be handled, because their “type” is known in advance or has been defined in advance.

Whenever the acoustic signals to be exploited for fitting the hearing device 1 as of FIG. 1 are known such as e.g. pre-recorded, there may be no need to perform an online signal type analysis as is in fact necessary for in situ exploiting daily surrounding signals for user fitting. In this case the categorizing unit 5 of FIG. 1 such as a hardware unit may be omitted. This is shown schematically and simplified in FIG. 3.

A pre-established acoustic signal to be used or which is suited as a fitting test signal for the active device 1 is pre-recorded. The “type” of such signal is also known. E.g. it may have been found by previous signal analysis and categorizing. The signal as well as its “type” may be pre-recorded e.g. on a player unit 17, a CD player, a chip, etc. Whenever a known and pre-recorded acoustic signal or its electric representation is selected such as e.g. on the unit 17, the “type” of the selected signal is also known. The information of “type” of the signal selected is entered to input 17 e.g. by an audiologist.

Alternatively and as shown in dashed lines in FIG. 3, this “type” information may automatically be input to the conversion unit 7 from the player unit 17, at which the respective signal is selected.

The ST/ASA conversion unit 7 may be construed in analogy to that which was exemplified with the help of FIG. 2, i.e. by selecting and inputting manually or automatically the respective “type” of acoustic signals—and possibly of additional parameters as was addressed—a respective selection of preferred adjustments is output at A₇.

Nevertheless, it is perfectly clear that also prerecorded acoustic signals or their respective electric representations may be applied to a determination unit 5ₐ as shown in FIG. 2, leaving it up to analyzing—11—and categorizing—13—such signals to establish their “type”.

Thus, acoustic signals or electric signals representing such acoustic signals suited for fitting the active hearing device 1 may be prevailing or may be recorded. For making use of—online—daily surrounding signals as for user fitting a signal type analysis is performed so as to categorize such signals into signal types. For prerecorded signals their type may be pre-established.

With an eye on FIG. 1 we have yet left open how the fitting test signals are applied at I₁ to the active hearing device 1 as well as to the ST/ASA conversion unit 7, thereby possibly via the categorizing unit 5. As was addressed above it may not be necessary at all to present an acoustic—or electric—input signal to the device 1, if fitting operation is performed just on the basis of “type” information, such as e.g. for default fitting.

According to FIG. 4a the acoustic signal AS as of FIG. 1 is picked up by a microphone arrangement 20, the electric output of which being led to both the electric input I₁ of active hearing device 1 as well as to the electric input I₅ₐ of the categorizing unit 5ₐ. As shown in dotted lines and as an example, in the interconnection between the output of the microphone arrangement 20 and the electric input I₁ there might be provided a processing unit 22. In fact, in either of the two signal paths to the respective inputs I₁, I₅ₐ or in both an additional processing unit such as unit 22 may be provided to first appropriately tailor the respective electric signals.

As also shown in FIG. 4a the electric signals which represent the prevailing acoustic signal AS may also directly be derived from an electric signal source, such as from a player unit 21, whereat prerecorded signals are selected. Thus, in this embodiment a prevailing acoustic signal AS is fed to the categorizing unit 5ₐ as well as to the hearing device 1 as an electric signal.

The embodiment of FIG. 4b is similar to that of FIG. 4a. It shows the simplified embodiment if known acoustic signals AS are used, wherefrom the “type” too is known. As a difference to the embodiment of FIG. 4a and as was already addressed the conversion unit 5ₐ may be omitted and the “type” of prevailing acoustic signal AS is directly entered to the ST/ASA conversion unit 7. Entering the sound “type” at unit 7 may thereby be performed manually or automatically. Latter is especially realized whenever, as shown in dashed lines, the known acoustic signals are recorded together with their “type” information, as in a recording unit 21.

A further embodiment is shown in FIG. 4c. Principally in this embodiment the prevailing acoustic signal AS is fed to the active hearing device 1 as an acoustic signal and, accordingly, input I₁ as of FIG. 1 is an acoustic input. From the acoustic input I₁ of the hearing device 1 the acoustic/electric conversion is performed by means of an acoustic/electric converter arrangement 24 integrated in the device 1, i.e. a microphone arrangement 24. Further, the acoustic signal AS is converted to its electric representation by a microphone arrangement 26, the output thereof being operationally connected to the electric input I₅ₐ of the categorizing unit 5ₐ.

Thus, in this embodiment and with an eye on FIG. 1 input I₁ is an acoustic input, whereas I₅ is an electric input.

According to FIG. 4d a known acoustic signal AS is input to the acoustic input I₁ of the device 1, whereby in analogy to FIG. 4b the “type” of signal is input either manually or automatically directly to the conversion unit 7. Again in dashed lines, the use of a player unit 21 is shown in this embodiment, whereby the acoustic signal AS is generated via a loudspeaker to input I₁ and “type” setting may be performed automatically by the player unit 21.

According to FIG. 4e the acoustic signal AS is input to the acoustic input I₁ of the device 1. Thereby, the microphone arrangement 24 inherent to the device 1 is also used for acoustic/electric conversion of the acoustic signal AS to be input to the input I₅ₐ of categorizing unit 5ₐ. Therefore, there is provided at the hearing device 1 an electric output A₁ₐ from which the acoustic/electrically converted signal is led to the input I₅ₐ.

Already here it may be seen that with respect to allocation of the units 5a and 7 as of FIG. 1 the embodiment of FIG. 4e leads to incorporating these units directly into the hearing device 1 which finally leads towards incorporating all the additional units used for fitting the device 1 directly into such device 1.

As has been described above principally the unit 7 outputs an indication about which adjustments shall preferably be acted on for fitting the hearing device at least with respect to a specific type of acoustic signal. The indication of which adjustment shall be acted on may thereby comprise one or more than one transfer characteristics or programs of the device 1 and thereby specific adjustable parameters of such characteristics or programs. The unit 7 does not provide for a quantitative indication, namely of the extent to which such adjustment is to be performed, i.e. how much parameters have to be varied. This because such quantitative adjustment may mostly be accurately performed only based on the knowledge of a target which latter is finally only defined by a consumer individual.

As shown in FIG. 1 the adjusting member 9 most generically will perform the quantitative adjustment at electronic unit 3 on one hand based on the ASA-information, i.e. about which program and parameter is to be acted upon, further based on the information of how the prevailing transfer characteristic behaves and thirdly based on the information of how the transfer characteristic should be optimized still for a specific acoustic test signal.

Thus, in the following different embodiments shall be discussed with respect to realizing the quantitative adjustment of the electronic unit 3, departing from the adjustment advice ASA at the output of conversion unit 7.

The embodiments are different dependent on how adjusting member 9 as generically shown in FIG. 1 is put into practice.

In a first embodiment according to FIG. 5a the adjustment selection advice S_{ASA} from the conversion unit 7 is fed to a machine/man interface such as e.g. to a display unit 27. Thus, e.g. on such a display there will appear the indication of which program or which programs and which parameters at such program or programs should predominantly be adjusted for fitting the hearing device 1 for a specific prevailing acoustic signal. Still according to the embodiment of FIG. 5a the output signal A₁ as of FIG. 1 of the active hearing device 1 is also fed to a machine/man interface such as to a display unit 28. Thereby, the signal Al exploited here to be displayed at the display 28 may directly be the electric signal output from the electronic unit 3 or may be, as shown in dashed lines, provided by sensing the mechanical output signal of the device 1 such as e.g. the acoustic output of an output electric/acoustic converter of the device 1. Be it by reconverting the signal from the mechanical output A₁ or be it directly by exploiting the signal at the electric output A₁ of device 1 in any case there is displayed at the interface 28 a prevailing result dependent on the prevailing transfer characteristic of electronic unit 3 upon the prevailing acoustic signal AS as of FIG. 1.

Thus, an individual ID1 has present the result of the prevailing transfer characteristic—INFO PREV.—and further the information—INFO ADJ.—about which adjustments are preferably and predominantly to be acted upon at unit 3 if the prevailing characteristic's result is not satisfying.

The individual ID1 further knows as shown in FIG. 5a schematically by INFO DES the desired transfer characteristic's result and will, based on the difference of the prevailing information INFO PREV and the information about the desired result, INFO DES, act on those adjustment facilities, programs and parameters which are proposed by the INFO ADJ.

In a further embodiment as schematically shown in FIG. 5b one part of the task to be performed by the individual ID1 as of FIG. 5a, namely that of establishing the difference between prevailing result and desired result, is automated, i.e. machine performed.

Thus, according to FIG. 5b there is formed at a comparison unit 29 a difference Δ between the result of the prevailing transfer characteristic at device 1 and a desired result. As an example, there is provided a modelling unit 31. A signal which represents the prevailing acoustic signal AS as of FIG. 1 is applied to the input I₃₁ of the modeling unit 31 and the information about the “type” of prevailing acoustic signal is derived from the input side of the conversion unit 7 and also applied to the modeling unit 31. On the basis of “type” information in the modeling unit 31 there is selected in unit 31 a desired transfer characteristic which has been experienced as optimum for that type of acoustic signal. Thus, in fact the modeling unit 31 establishes for a model of optimally fitted hearing device 1 at least for specific acoustic signals. The signal input to I₃₁ is acted upon by the type-dependently selected optimum transfer characteristic so that at the output A₃₁ a signal is generated which represents the desired result to be established at the hearing device 1. At the output of comparator unit 29 there appears thus the signal Δ which represents the deviation of the prevailing characteristic result of device 1 from such desired characteristic result. Δ is displayed at a machine/man interface such as e.g. the display 33. The adjustment advice at the output A₇ of conversion unit 7 is again displayed e.g. at the display unit 35. Thus, the individual ID1 is informed on one hand of the preferred adjustment to be acted upon by INFO ADJ as well as by the quantitative information INFO Δ about the difference of prevailing result and desired result. It is still up to the individual ID1 to more or less accurately adjust the electronic unit 3 of device 1 so as to reduce the deviation Δ. As in this embodiment there is in fact provided a model of the optimal hearing device transfer characteristic specifically at least for each type of acoustic signal presented, a further embodiment consists of directly acting with the deviation Δ upon the adjustment facilities of the electronic unit 3. Thereby, the adjustment advice information which is realized by the ST/ASA conversion unit 7, which is still common to all embodiments of the present invention, is exploited too: The adjustments to be performed are still selected in dependency of the output of conversion unit 7 and are quantitatively performed as controlled by the desired result to prevailing result deviation Δ. This fully automated fitting adjustment is shown in dashed lines also in FIG. 5b. Exploiting the output ASA information of unit 7 allows, also in fully automated fitting, as exemplified in FIG. 5b, to more rapidly and efficiently act upon the most effective adjustment possibilities provided at the electronic processing unit 3 of device 1.

As shown in the embodiments of FIGS. 5a and 5b the output signals of the device 1 is either exploited as an electric signal or, if exploited as a mechanical output signal, is reconverted to an electric signal which may also be done in the embodiment of FIG. 5b. Therefore, these embodiments are primarily suited for fitting the respective active hearing device 1 ex situ, which is done predominantly for default and preliminary fitting. For individual fitting and for user fitting of the device 1 to specific needs of an individual which wears such device 1, this individual is to be integrated in the quantitative adjustment proceeding downstream of the conversion unit 7 as of FIG. 1. An embodiment applied for in situ fitting to an individual is shown in FIG. 5c. Thereby, an individual ID2 wears the hearing device 1, which thus acts by its output electric/mechanical converter arrangement 35 upon individual ID2.

The individual ID2 to which, in situ, the hearing device 1 is to be fitted does evaluate from listening to the prevailing acoustic signal AS as of FIG. 1 the deviation Δ′ of the perceived signal to his individual perception needs. The individual ID2 and according to the embodiment of FIG. 5c e.g. orally transmits that information INFO Δ′ to the fitting individual ID1 who receives the adjustment advice information INFO ADJ e.g. as was explained in context with the FIG. 5a embodiment. Clearly instead of communicating the INFO Δ′ orally to the fitting individual ID1 such information may also be communicated from ID1 to ID2 electronically in that the individual ID2 makes use e.g. of a well-known scaling unit, whereat e.g. perceived intensity levels may be numerically scaled and transmitted to the fitting individual ID1. The embodiment of FIG. 5c is e.g. applied for individual fitting.

In a still further embodiment according to FIG. 5d the individual ID2 which is wearing the device 1 is simultaneously the fitting individual as of ID1 of the embodiment of FIG. 5c. Thereby, as a difference to the embodiment of FIG. 5c, at the output side of ST/ASA conversion unit 7 the adjustment advice is displayed in a most easily understandable manner. As shown in FIG. 5d this is e.g. performed by transmitting the adjustment advice S_{ASA} to the hearing device wearing individual ID2 by a speech advice, via an output speaker 40 at the output of conversion unit 7. Thereby, the adjustment facilities which are operable by the individual ID2 are also reduced and are easily to be operated. They may be e.g. program selection ability and loudness control. Accordingly, the speech advice will be restricted e.g. to the advice as to which program, i.e. transfer characteristic, to be selected by the individual ID2 and, once selected at the hearing device 1, the individual may just vary the loudness.

At a further embodiment which departs from that schematically shown in FIG. 5d and according to FIG. 5e the categorizing unit 5 as of FIG. 1 as well as ST/ASA conversion unit 7 are integrated within the hearing device 1. Switched into fitting mode (not shown) the prevailing acoustic signal of acoustic surrounding to the individual ID2 wearing the hearing device 1 is analyzed with respect to its “type” and from the output of conversion unit 7 a speech signal of adjustment advice S_{ASA} is transmitted via the electric/mechanical output converter of the device 1 to the individual ID2 in situ. Upon the advice, e.g. to adjust volume in one or the other of the programs, the individual ID2 may easily and in its actual acoustic surrounding, switch the hearing device to the respective program which is predominant for processing the prevailing type of acoustic signal and may there adjust the volume up to perceiving the prevailing acoustic signal according to his proper instantaneous needs. This fitting accords with user fitting as defined above.

Looking back on the different embodiments described for realizing the present invention, the skilled artisan is led to a multitude of further possibilities to advantageously apply the ST/ASA conversion. Thereby, different possibilities also become evident with respect to integrating at least a part of the units that were described into the hearing device.

By the present invention, e.g. realized by the embodiment of FIG. 5d or 5e, a fitting method and respective apparatus is realized that is sensitive for real-life hearing experience optimization in an improved manner. Real-life sounds are getting easily exploitable for fitting the hearing device, be it within a specialized office such as of an audiologist or be it for continued fitting by the individual wearing the specific device in situ and in real-life. With an eye on user fitting in real-life there is no need for a specialized person accompanying the individual wearing the hearing device, which would make real-life fitting impracticable.

Due to the fact that in some embodiments voice instructions are given by the hearing device to the individual from the inventively applied ST/ASA conversion unit such real-life fitting procedure becomes most easily feasible.

By inventively providing, within the fitting system, the ST/ASA conversion unit it becomes also possible e.g. for an audiologist, to record in normal life acoustic signals he feels representative for his customer's normal acoustic surrounding such as e.g. speech of a certain language and to present such acoustic signal as pre-established and recorded acoustic signals of pre-established type or to have such signals flexibly analyzed and categorized in “types” online by a categorizing unit as was described.

Thereby, also for a specialized person such as e.g. default fitting or for preliminary fitting it is a significant advantage to receive information about where to perform fitting adjustments upon specific acoustic test signals.

Whenever a customer complains about unsatisfying signal transfer by his hearing device in certain acoustic situations, the audiologist or more generically the person fitting the device may select a respective audio signal and receives as a significant help information, information about which transfer characteristic and thereat which parameters to vary so as to cope with customer's problem at that specific acoustic situation and without affecting and possibly negatively affecting the behavior of the active hearing device in other acoustic situations. Thus, the generic aspect of the present invention, namely to provide for a signal-type to adjustment selection advice conversion, facilitates default fitting, preliminary fitting, as well as individual fitting and further in fact renders user fitting practicable.

1. A method for manufacturing an active hearing device which is fitted towards the needs of an individual comprising
manufacturing an active hearing device with at least one adjustable transfer characteristic between an acoustic input signal and a mechanical output signal;
categorizing an acoustic signal to be applied as a fitting signal as being one of several pre-established types of signals;
automatically determining from said one type a selection of preferred adjustments to be acted upon at said device;
acting on at least one adjustment selected from said selection.

2. The method of claim 1, wherein said categorizing comprises analyzing said prevailing acoustic signal.

3. The method of claim 2, wherein said categorizing further comprises comparing a result of said analyzing with predetermined values defining said pre-established types of acoustic signals.

4. The method of claim 2, wherein said analyzing comprises spectral analyzing of said prevailing acoustic signal by at least one of the following methods:
analyzing basic acoustical parameters;
analyzing acoustic indicators of content type of acoustic signal;
analyzing acoustic indicators of specific acoustic source;
analyzing acoustic indicators of the probable hearing target being associated with the acoustic signal.

5. The method of claim 1, wherein said selection of preferred adjustments comprises indication of one or more than one adjustment parameters of one or more than one transfer characteristics of the hearing device and an indication of the respective transfer characteristic.

6. The method of claim 1, wherein said selection of preferred adjustments depends additionally to one or more than one of the following factors:
current settings of the hearing device;
individual hearing loss of the user of the hearing device;
individual listening needs of the user of the hearing device;
deviation of the current settings of the hearing device from a pre-established output target for said acoustic signal;
previously selected adjustments for the same or for other acoustic signal types;
result of previous adjustments for the same or for other acoustic signal types.

7. The method of claim 1, further comprising pre-recording said acoustic signal to be applied.

8. The method of claim 7, further comprising pre-categorizing said pre-recorded acoustic signal.

9. The method of claim 8, further comprising performing said automatic determining from the result of said pre-categorizing.

10. The method of claim 1, further comprising applying said acoustic signal to be applied by means of the result of an acoustic to electric conversion to said hearing device and/or to said categorizing.

11. The method of claim 1, further comprising presenting said acoustic signal to be applied to an acoustic to electric converter arrangement of said hearing device.

12. The method of claim 1, further comprising displaying a signal depending on said output signal of said device and displaying said selection of preferred adjustments to an individual, said individual acting on said at least one adjustment.

13. The method of claim 12, said signal depending on said output signal comprising one or a combination of the acoustic indicators mentioned in claim 4.

14. The method of claim 12, further comprising providing for said individual information about a target of said output signal, said individual performing said acting upon said adjustment as a function of said output signal display, said selection of preferred adjustments display and said target information.

15. The method of claim 1, further comprising electronically providing a desired output signal of said hearing device for said acoustic signal being applied, forming electronically a deviation signal between the output signal of said hearing device and said desired output signal, feeding information about said deviation signal to an individual, feeding to said individual information about said selection of preferred adjustments, said individual performing acting upon at least one adjustment as a function of said information about selection of preferred adjustments, information about said deviation.

16. The method of claim 1, further comprising applying said hearing device to an individual and displaying information about said selection of preferred adjustments to said individual, said individual acting upon at least one adjustment of said selection.

17. The method of claim 16, wherein said information about selection of preferred adjustments is transmitted to said individual by an automatically generated acoustic speech signal.

18. The method of claim 17, further comprising performing at least said automatically determining within said hearing device and providing said individual with said information about said selection of preferred adjustments via an output electric to mechanical converter of said hearing device.

19. The method of claim 1, further comprising applying said acoustic signal to be applied to a first individual via said hearing device worn by said first individual, providing information of said selection of preferred adjustments to a second individual;
providing information about hearing perception of said first individual to said second individual and performing said acting upon at least one adjustment out of said selection.

20. A fitting system for a hearing device comprising a unit with an input operationally connected to an acoustic signal source and generating at an output a signal representative of a selection of preferred adjustments to be acted upon at a hearing device for fitting same with respect to a specific signal.

21. The system of claim 20, wherein said unit is integrated into a hearing device.
